(19) United States
(12) Patent Application Publication
(10) Pub. No.: US 2003/0136909 A1
(43) Pub. Date: Jul. 24, 2003

(54) High temperature quantum well photodetectors

(76) Inventor: James Plante, San Diego, CA (US)

Correspondence Address: Joseph Page, Page Lohr Associates, P.O. Box 757, La Jolla, CA, 92038, US

(21) Appl. No.: 10/057,381

(22) Filed: Jan. 23, 2002

(51) Int. Cl. G01T 1/24

(52) U.S. Cl. 250/338.4; 250/352; 250/370.15; 257/21; 257/22; 438/94

(57) ABSTRACT

A special infrared photodetector is operable at high temperatures. The detector is a very wideband detector which may be operated in a direct detection mode or in a heterodyne mode. A multiple quantum well photodetector includes a plurality of wells and a plurality of barriers formed of alternating layers of gallium-arsenide and aluminum-gallium-arsenide material respectively. The gallium-arsenide layers are highly doped with an n-type dopant such as silicon atoms. The high doping produces an unexpected result of improved operational efficiency at elevated temperatures. Photodetectors of these inventions have a large number of quantum well structures to improve absorption or interaction cross section. In all versions, the middle portion of wells include a special region of a highly doped gallium arsenide material in a density of about one to three trillion silicon atoms per square centimeter.

### SPECIFICATION FOR A LETTERS PATENT

1. Field

In general, these inventions relate to special arrangements of quantum well type semiconductor infrared photodetectors, and in particular, these inventions relate to arrangements and use of quantum well photodetectors at elevated temperatures.

2. Background of these Inventions

Although optical detector technologies are mature, new types of detectors are being developed in response to novel demands on measurement systems parameters. These demands sometimes relate to improving sensitivity under various operating conditions. State of the art photodetectors therefore come in various forms and with varied associated functionality.

A type of photodetector of particular interest is the quantum well type photodetector sometimes and herein called QWIP. A quantum well is a physical structure formed by multiple layers of materials having similar but not identical composition. These layers create boundary conditions which operate to confine electrons therewithin one of the layers; a ‘well’ layer. Under special circumstances, an electron can escape the bound condition and quit its confinement within the well. That electron may thereafter operate as part of a current in other electronic processes. For example the electron may be promoted into a conduction band where it may be further amplified in circuits coupled to the multiple layers. One of the conditions which may cause an electron to leave its bound state is the interaction with and tendency of an electron to absorb a photon thereby increasing its total energy. Thus, an electron can change from a first energy state to an excited energy state after absorbing the energy of a photon. For electrons held in a quantum well, this means the electron can move from a bound state to a free state in view of a photon absorption event.

QWIPs have all sorts of interesting properties. QWIPs are highly stabile devices. While some photodetectors made of exotic materials are highly sensitive to, for example temperature or over currents, QWIPs are not. QWIPs are rugged, hearty devices which cannot be easily broken Unlike most photodetectors where the precise nature of the material composition effects their performance, energy levels of QWIP transitions are not affected much by their composition. This is due to the difference between the electron absorption mechanism of a common PIN photodiode in comparison to the conditions upon which an electron escapes a quantum well. In a PIN photodiode, electrons may exist in energy bands arising from the state of atomic sites. Thus, electrons may be bound to these energy bands (valence and conduction for example) in connection with molecular properties, or the composition of the device material. A QWIP device is unique in comparison because electron transitions are characterized as ‘intraband’; an electron may remain within, for example, a conduction band in both trapped and escaped states.

QWIP electrons are bound in wells formed from layers of like materials. These layers may have similar but not identical crystal structures. Thus, many types of materials can be used to form the quantum well structures. This is a great advantage because materials with which we have great experience and control may be used. For example, GaAs and AlGaAs are two semiconductor materials we know a great deal about as their use is common in many of the semiconductor arts. These materials have very similar crystalline structures and these structures are easily formed with great precision.

Typically, a QWIP is designed to be responsive in optical wavelengths of the infrared IR spectral region. Because QWIPs are most generally IR devices, they are highly sensitive to heat sources including the detector itself and may be electronically noisy at high temperatures. The temperature of the device itself may trigger spurious currents which falsely appear as photonic signal inputs. Accordingly, most arrangements have QWIP devices operated in a hyper-cooled state. Cryogenic cooling is almost always employed in conjunction with use of QWIP devices. This is not generally a problem because QWIPs are not a common consumer device used in everyday environment, but rather are a specialized laboratory apparatus used under the strict control of a well equipped laboratory environment. This includes use in dewers of liquid nitrogen or other liquefied gas. Where it is desirable to use a photodetector outside a laboratory, a PIN type photodiode is more appropriate. Albeit, the performance both in sensitivity and speed of a PIN can be less than a QWIP. Accordingly, PIN type detectors are ubiquitous while QWIPs are relegated strictly to advance laboratory environments.

There has been little or no motivation to run a QWIP at elevated temperatures. Because test laboratories enjoy plentiful supplies of liquid nitrogen and most scientists are very comfortable with its use, there is little or no stimulus to explore configurations which do not require cryogenically cooled arrangements. Further, most applications and experimental uses of IR detection tend to strive for the very best performance possible in view of signal strength and speed with little regard for operation at elevated temperature. It would be counterintuitive to give up sensitivity and speed to achieve operation at high temperatures because cooling is trivial to the expert scientist. Accordingly, the art is completely devoid of systems which are directed toward fast IR detection systems operable at elevated, or non-cryogenic temperatures. Thus, designers of QWIP detectors tend to form them in agreement with design constraints compatible with cryogenic cooling. QWIP use outside the advanced cryogenically equipped laboratory might otherwise be considered prohibitive.

### SUMMARY OF THESE INVENTIONS

Comes now, James Plante with inventions and discoveries of high speed infrared QWIP photodetectors sensitive at elevated temperatures. Thus, these inventions also include particular new uses of QWIP type photodetectors. Special versions of these inventions include unique arrangements of multiple quantum well structures to form high speed photodetectors for detection of infrared optical radiation at high temperature. Devices arranged with highly doped well layers show improved sensitivity performance at high temperature. In addition to these, photodectectors may also be arranged in combination with special thermo electric cooling apparatus. While these cooling apparatus will not provide cooling to the degree a cryogenic system would, they will nevertheless improve performance. More importantly, these special cooling systems are free of complex apparatus which is difficult to maintain and operate. Thus, the combination of a highly doped QWIP with a special cooling apparatus forms a novel apparatus not previously contemplated.

Highly doped photodetectors of these inventions have a large number of quantum wells, each of which comprises a well portion and barrier portions on either side thereof Further, well portions include a special region of highly doped gallium arsenide material, the doping preferably being n-type dopant of silicon atoms in a density of about one to three trillion silicon atoms per square centimeter.

### OBJECTS OF THE INVENTION

It is a primary object of the invention to provide new high speed photodetectors.

It is an object of the invention to provide photodetectors for use in the infrared portion of the optical spectrum.

It is a further object to provide photodetectors which do not require complex and expensive cooling systems.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by the claims, but do not appear here as specific examples. It will be appreciated that a plurality of alternative versions are possible.

### BRIEF DESCRIPTION OF THE INVENTION

These and other features, aspects, and advantages of the present invention will become better understood with regard to the following description, appended claims and drawings where:

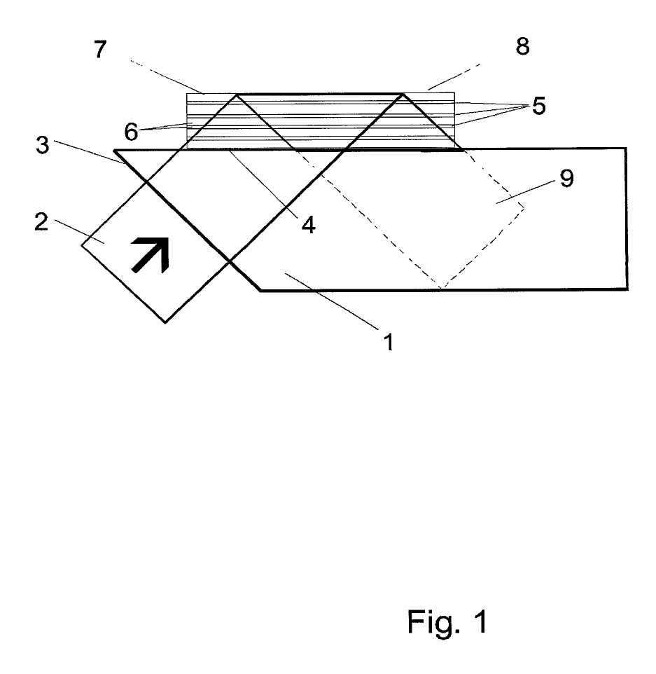

FIG. 1 is a block diagram of a preferred photodetector of these inventions;

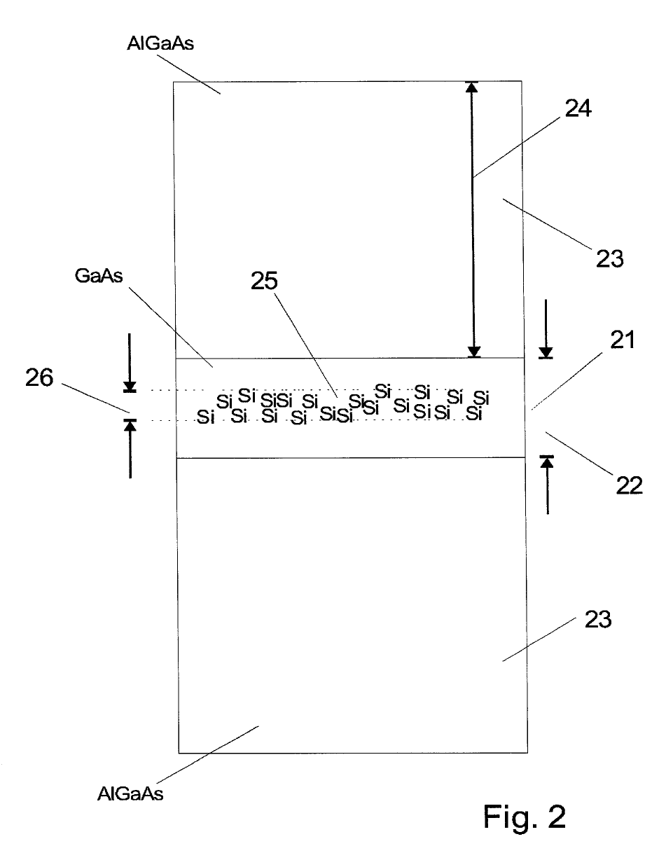

FIG. 2 shows a special structure of a well layer of a multiple quantum well photodetector of these inventions; and

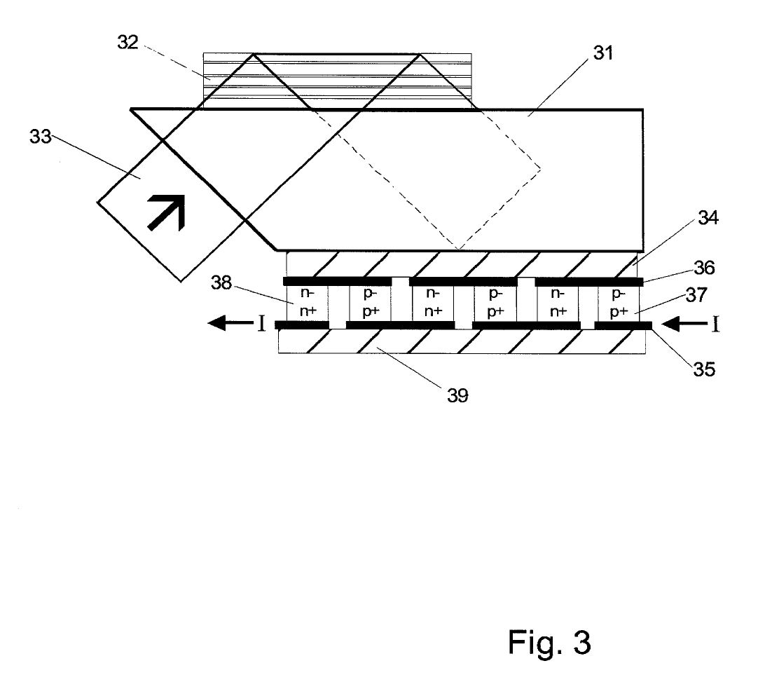

FIG. 3 illustrates a QWIP device combined with a thermo electric cooler.

### PREFERRED EMBODIMENTS OF THESE INVENTIONS

While exploring data and results relating to heterodyning experiments of a certain QWIP configuration a peculiar effect was noticed. Operated in the normal fashion, i.e. in a cryogenically cooled state, a QWIP was arranged with a heterodyne input signal. The heterodyne local oscillator was increased in power until it was quite high. This was done in search of a point where heterodyne performance would be expected to degrade. However, the degradation was not found; but rather the device performed well with the high input power. This particular detector performed well even when an exceptionally large local oscillator power was applied. Although the experiment was performed to determine heterodyning characteristics, an unexpected result occurred from knowledge gained with regard to the applied high power in the local oscillator. While the device was cooled to liquid nitrogen temperature, it was understood that the large power input signal must be causing local heating at the detector. Although the detector was in a dewer at low temperature, it was suspected the active area of the device was at a far higher temperature.

As part of the inventor's system objectives includes a detector which could perform at elevated temperature, the conclusion was reached that the device noted above may perform well in elevated temperatures. In either heterodyne or more importantly in direct detection, that particular QWIP seemed to maintain reasonably good detectivity at temperatures higher than cryogenic temperature. The unexpected discovery of good performance in heated QWIPs partly led to the notion that these devices may be used in a high temperature mode, whether heterodyne or not, as the performance at high temperatures was unusually good.

In accordance with each of the preferred embodiments of these inventions, new QWIP photodetectors and photodetector combinations and new uses thereof are provided. Detector devices of these inventions are arranged for operation at elevated temperatures. In advanced versions, special QWIP devices are combined with a thermo electric cooling or TEC arrangement to form high performance detectors which do not require elaborate or complex cooling support apparatus. These preferred versions of QWIP detector/cooler combinations show still further improved performance at TEC temperatures due to a high level of doping applied in construction of the QWIP. Although these devices do not have performance characteristics, for example detectivity, equivalent to known devices at cryogenic temperatures, they display better performance at elevated temperatures where common QWIPs fail to function well. Accordingly, the effect may be viewed as a temperature/performance trade-off.

Advanced versions of QWIPs combined with TECs allow good detectivity at easily manageable temperatures. A TEC is a device which uses gradient doped structures to allow an electron or ‘hole’ carrier virtual ‘gas’ to expand as a common gas does resulting in a temperature drop in accordance with the ideal gas law PV=nRT. Temperatures achievable with these devices cannot compete with temperatures readily available with cryogenic apparatus, however, a great advantage is to be had in that these devices are compact and simple and require little or no maintenance. In addition, they fit well in a small package; an ideal feature for mass market systems which are to be used outside a laboratory environment.

A brief review of principles relating to growing crystals is presented here. The following sections describe particular crystal structures formed in various processes. Of the most important is the molecular beam epitaxy process. This process allows very great control over crystal thickness where the thickness dimension is critical.

Molecular Beam Epitaxy MBE

Generally, MBE machines consist of three vacuum sections, of which a growth chamber is most important. A buffer section is used in the preparation and storage of wafers before being placed in the growth chamber. A ‘load lock’ is used to insert and remove samples while retaining integrity of vacuum. Samples are loaded onto a rotational magnetic holder Continual Azimuthal Rotation, CAR. Cyropanels are used in conjunction with the vacuum system to keep partial pressure of undesirable gases such as CO₂ and H₂O around 10⁻¹¹ Torr. The principle of operation is that gaseous substances are bound to the cold surfaces within the pump by means of cryocondensation, cryosorption or cryotrapping. Epitaxial growth starts with the many heated cells, called effusion cells or Knudsen cells, that contain a compound required for the addition of a particular atomic species into the vacuum chamber. Each source is independently heated until atoms of the source material are able escape by thermionic emission. An advancement of MBE, Gas Source MBE (GSMBE), uses room temperature gases for the source materials, thus avoiding significant contamination problems and necessarily higher substrate temperatures that can cause segregation of dopant atoms. Within an ultra-high vacuum, free atoms have a long mean-free path and collisions with other atoms are infrequent. Atoms from the sources are able to travel in a straight line until they collide with the substrate material. A computer may be used to remotely operate shutter controls, allowing the emission of different species of atom to be directed at the substrate. The typical rate of growth with MBE is around a single mono-layer, in some cases of the order of 1 angstrom, per second. Although slow, this allows for abrupt changes in material composition. Under the right conditions, the beam of atoms will attach to the substrate material and an Epitaxy layer will begin to form

Multiple quantum well photodetectors of these inventions can be formed in molecular beam epitaxy processes. Crystalline structures are carefully grown layer-by-layer in a serial fashion. Manipulation of molecular beams effects the outcome of the crystalline structure. When forming well layers, a special portion of the layer includes a step whereby a dopant, for example silicon atoms, is added to a gallium arsenide beam

Forming a High Temperature Infrared Photodetector

In accordance with these inventions, methods of forming high temperature, wideband, infrared photodetectors include steps as follows: forming a wafer substrate of GaAs; forming elements configured as support electronics on the substrate; forming on the support electronics a multiple quantum well stack; and forming an ohmic contact layer of doped GaAs material on the stack.

Forming a stack is more precisely defined as including the following substeps: forming a well layer; forming a barrier layer; and repeating those steps in succession to form a repeating structure. Although preferred versions include stacks of more than 70 repeat structures, other version may have 100 or more wells.

Formation of the well layer is described in better detail as follows: a first buffer portion is formed of pure undoped GaAs material; a doped portion is formed by introducing silicon atoms in a highly regulated fashion to GaAs; a second buffer portion is formed of undoped GaAs material.

To more fully understand these inventions, one might start by considering the drawing of FIG. 1 where a substrate 1 supports entry of an optical beam 2 through angled facet 3 and transmission therethrough. The beam further propagates out of the substrate through junction surface 4 and into a quantum well stack. The quantum well stack is comprised of a plurality of well regions 5. A stack of repetitive layer structures 6; a layer pair comprising one barrier layer and one well layer, forms the ‘active region’. Although only a few repeat units are shown for clarity, a typical device may have many more repeat units. The top layer 7 may provide electrical contact to the stack from the top surface. In addition, the top layer includes a mirror thus causing beams incident thereupon to be reflected as beam 9 to propagate through the stack a second time improving interaction cross section. Although further details are presented with regard to substrates in following sections, electrical and thermal coupling, the immediate following discussion is directed to the stack of well and barrier layers which form an active region

Top Layer

The top surface 7 of the multiple quantum well stack has very special properties and fraction. First, the top surface is used as a special electronic contact. Secondly, the top surface of the multiple quantum well stack operates as a total internal reflection TIR mirror. A beam which passes from the substrate into the multiple quantum well stack at a sufficient angle with respect to the top surface will be completely reflected back into the stack. This arrangement is important because it allows the beam to interact with each well twice thus increasing absorption and reducing the total number of wells necessary for a particular desired absorption level. Since only a fractional portion of a beam's energy is absorbed by each well, it becomes necessary to pass the beam through several wells in serial fashion. Each successive well through which the beam passes further contributes to the strength of a detector output electrical signal. In a double pass system, the beam interacts with each well twice, i.e. once for each pass through the device.

Active Region—Multiple Quantum Well Stack

The active region of a QWIP includes a plurality of layers where photonic inputs interact with matter to create electronic currents which may be improved in electronic amplification stages.

One first layer and one second layer together as a ‘layer pair’ 6 forms the structures repeat unit. Herein this disclosure, one layer is sometimes referred to as a ‘well’ layer, while the other layer is sometimes referred to as a ‘barrier’ layer. In preferred versions, a well layer is formed of a doped GaAs material and a barrier layer is formed of AlGaAs. GaAs well layers may be thin with respect to AlGaAs barrier layers. While GaAs materials and derivatives thereof are well known and thus good candidates for use in QWIP devices, it is recognized here that the function of a quantum well does not rely upon the material from which it is made, but rather, the thickness of the layer is the controlling effect. Thus, materials other than GaAs and AlGaAs may be used to arrive at an equally attractive device without deviation from the intended scope of the invention

A multiple quantum well active region is formed from a plurality of alternating layers of material. The layers are preferably crystals formed in molecular beam epitaxy processes such that their dimensions, i.e. thickness, are highly regulated and necessarily precise. While one of the layers is referred to as a ‘well’ layer, experts will appreciate that a well is more precisely formed when the well layer is bound on both sides by barrier layers. It is the boundaries between layers that bring about conditions which ‘trap’ an electron therein the well layer. Thus, it is sometimes preferable to consider the barrier-well-barrier structure as one.

In preferred versions, a well layer is a crystal layer of doped GaAs material preferably formed in via molecular beam epitaxy. The layer may be grown onto a previously existing layer of different but similar crystal material and that previous layer acts as a seed to begin the well layer. A well layer may be a few nanometers in thickness and up to about ten nanometers. The entire well layer may be envisaged as having three portions. A first buffer portion of pure GaAs, a doped portion of GaAs and a dopant, and a second buffer portion of pure GaAs. The buffer portions are provided on either side of the doped portion and protect the well doped portion from contact and interaction with barrier layers which are constructed and formed on either side of a well layer. The thickness of a buffer portion may be about a single nanometer. The thickness of the doped portion may be several nanometers.

While forming the doped portion in a standard molecular beam epitaxy process or other similar process, silicon atoms may be introduced at a highly regulated rate. Silicon is introduced such that a density of between one and three trillion atoms per square centimeter is attained. This dopant level is higher than otherwise used in other QWIP devices. It is this highly doped well layer which in part provides the unusual and unexpected temperature response that allows these devices to remain efficient and operable at non-cryogenic temperatures.

Although best modes anticipate use of silicon atoms as a dopant, it is not necessarily a requirement that silicon be used Other elements which are effective dopants may also be used in the place of silicon. Similarly, dopants described here are known as ‘n-type’ dopants. While ‘n-type’ is preferred in some embodiments, these inventions should not be limited to ‘n-type’ dopants as ‘p-type’ dopants may also provide is interesting and effective alternatives. In this regard, alternative dopants and doping strategies may be possible and meant to be included in these inventions.

A barrier layer is formed on either side of well layers. A barrier layer is preferably several times and up to 8 times thicker than a well layer. In one preferred version, a barrier layer is about 20-25 nanometers thick. In the example presented here as a best mode of the inventions, barrier layers are formed of AlGaAs material. More precisely, the crystalline barrier layer is comprised of AlₓGa₁₋ₓAs; where x≅0.2 Devices have been made where x≅0.2±0.04 and have demonstrated good and useful behavior. Barrier layers are otherwise homogenous and may be applied (grown) in a single step.

To form a multiple quantum well stack a plurality of well-barrier pairs are formed (grown) one on top the other in a unit called a mesa or a stack. The precise nature of preferred versions of a well and barrier pair construction can be more fully appreciated with reference to the drawing of FIG. 2. A well layer 21 is shown to have a thickness 22 which is small in comparison to a barrier layer 23, on either side of the well layer, having a thickness 24. A middle portion 25 of the well layer contains a dopant of silicon atoms in a very thin region of only one or only a few nanometers in depth 26. The silicon is only deposited in the mid portion of the well layer so the silicon atoms do not interfere with the AlGaAs—GaAs junction.

As mentioned above, the thickness of both the barrier and well layers may be adjusted to achieve various performance characteristics. For example, the peak absorption wavelength is dependent upon the thickness and thus a stack may be tuned for a particular wavelength via adjustments to the thickness of the various layers. For CO₂ lasers having a 10.6 μm wavelength, a preferred thickness for the GaAs well layer is about 5 nanometers, while the preferred thickness for the AlGaAs barrier layer is about 20 nanometers. The thickness of the well layer directly determines the energy states of electrons which are trapped therein and consequently the detector response wavelength

The width of the multiple quantum well structure is selected in view of speed and optical coupling issues. The smaller the width, the less impedance the device will have and the faster it can be. However, in the double pass configuration, one will appreciate that width is preferably more than 1.4 times the beam width. It is not a trivial matter to reduce a beam's width below a certain point. Although a multiple quantum well structure is quite fast when it is made with a 75 micron width, good beam coupling may become difficult if the multiple quantum well structure width is reduced by more than half again that size. Preferred devices of these inventions include those having a stack width between 20 and 200 microns.

Support Geometries

To realize a good detector, the following geometries and arrangements are preferred in some versions of these inventions. With reference to the drawing figures and following text, a more precise understanding may be realized.

Substrate

A foundation upon which a detector may be formed includes a base substrate 1 illustrated in FIG. 1. For example, some versions have an optically transparent substrate of bulk gallium arsenide GaAs material. The substrate is formed, or more precisely ‘grown’ in an epitaxy process. Layer upon layer of material from a melt is added to a seed pulled from the melt. A substrate may therefore be highly pure and have superior optical, electronic and mechanical properties. For example, the substrate is highly transparent at certain optical wavelengths. In addition, the substrate has good semiconductor properties which permit electronic interfacing. Finally, the substrate provides a rigid mechanical base upon which further elements and structure can be constructed.

Buffer/Amplifier

A special layer may be formed immediately upon the top surface of the substrate but before the multiple quantum well stack. This layer may be arranged as part of an electronic amplifier. Specifically, a field effect transistor may include a AlGaAs portion as a barrier between the amplifier's gate and channel elements. This same AlGaAs portion thus also serves as a starting point onto which the stack is formed. Although not directly part of the multiple quantum well stack, the layer lies between the substrate and the multiple quantum well stack. These layers are considerably thicker than a well or barrier layer. They are of the order of 100 nanometers thick and may be up to several hundred nanometers and perhaps even a micron thick. For preferred semiconductor properties, these regions may be uniformly doped to include silicon atoms in the crystalline lattice.

### Detector Couplings

For a more full and complete understanding of these combinations presented here, it is useful to describe details with regard to coupling. In particular, the solid state layered QWIP structure has special electronic coupling in view of the small signals and very high speeds. Further, these detector combinations require special consideration with regard to optical coupling. A prism arrangement is used to cause a double pass through the detector active region. Finally, the thermal coupling is a very important element. QWIP efficiency is increased with lower temperatures. Accordingly, attention is directed to a thermal coupling arrangement which allows the QWIP to operate a low temperatures without exotic cooling apparatus such as cryogenics.

Electronic Coupling

Atop the last layer-pair, a special bulk layer 7 of highly doped GaAs is provided for ohmic contact. This layer is neither a well nor a barrier but rather an electronic contact layer to which a conductor may be affixed or coupled. That conductor can pass a signal to the source of the amplifier mentioned above. Thus, the conductor transports a signal generated in the detector device to amplification circuits external to the detector. One will recall that the other side of the multiple quantum well stack formed another portion of the amplifier, the barrier between the gate and the channel. Accordingly, the construction of the multiple quantum well stack is highly integrated with the first stage electronic amplification circuitry by way of its physical structure on the substrate.

Optical Coupling

One structural element of importance is an optical coupling aperture. As the substrate is crystalline in nature, it can be ‘cleaved’ to form highly regular or smooth surfaces. Such a surface is useful for coupling an optical beam propagating in free space into the crystal substrate. A facet 2 which forms an entry aperture for optical beams can be formed in a cleaving process applied sometime after the crystal is fully grown.

The facet forms an angled surface with respect to a substrate longitudinal axis; in the example of FIG. 1, the facet forms a 45 degree angle. Angles other than 45 degrees are fully contemplated as various beam coupling strategies may require some changes or alterations.

The facet formed at an angle as described serves an important function. A multiple quantum well structure 3 is formed on the substrate surface opposite the facet as shown in the drawing. An optical beam which enters the substrate via normal incidence with respect to the facet propagates through the crystal to later become incident upon the surface 7, the top of the MQW structure. Said top of MQW structure is a surface having a high index of refraction discontinuity, the beam will be reflected away from the surface at the identical angle of which it is incident. As mentioned, the beam may be made to pass through the multiple quantum well stack twice. Since the angle of incidence in the presented example is 45 degrees the reflected beam will be orthogonal to the incident beam and those beams will not interact to form troublesome standing waves.

Thus an optically transparent rigid crystalline substrate of gallium arsenide having a cleaved facet at 45 degrees opposite a surface upon which a multiple quantum well is formed is the foundation of preferred detector devices of the invention.

Thermal Coupling

While QWIPs are preferably operated in cooled states, it is a primary advantage to dispense with cryogenic apparatus altogether. However, these QWIP detectors might still benefit from the cooling effects from a semiconductor device herein known as thermo electric coolers TEC. With reference to FIG. 3, one can fully appreciate that a special QWIP detector of high doping might be coupled to a TEC to form a preferred combination. Detector substrate 31 having QWIP active stack 32 thereon receives beam 33 as previously described. However, the substrate is thermally coupled by way of thermal pad 34 having a high thermal conductivity to the TEC device. The TEC device includes electrical circuit conductors 35 and 36 on alternating sides of gradient doped bulk semiconductor material of both ‘p’ type 37 and ‘n’ type 38. Currents driven through the device tend to cool the thermal pad side of the device and hence the detector by way of thermal conduction. More details with regard to the TEC operation are presented in the following graph.

Thermo Electric Coolers

Thermo-electric effects in semiconductors cause currents to flow due to temperature gradients but also cause temperature gradients when an electrical current is applied The thermoelectric cooler is a practical device in which a current is applied to a semiconductor causing a temperature reduction and cooling.

Thermo-electric coolers include multiple semiconductor elements which are connected in series. Doping density in semiconductor elements is graded with the highest density at the high temperature end and the low density at the low temperature end. An electrical current is applied to the series connection of these elements. ‘n’-type and ‘p’-type doped elements are used to ensure that carriers flow in the same direction. While in principle a single piece of semiconducting material could have been used, the series connection is typically chosen to avoid the high current requirement of the single element.

The operation of the thermo electric cooler is similar to that of a Joule-Thomson refrigerator in that an expansion of a gas is used to cool it down. While heating of a gas can be obtained by compressing it as is the case in a scuba cylinder, a gas can also be cooled by expanding it into a larger volume. This process is most efficient if no heat is exchanged with the environment as it would increase the lowest obtainable temperature. This is also refereed to as an isentropic expansion as the entropy is constant if no heat is exchanged.

The gas in a thermoelectric cooler is the electron or hole gas. As a constant current is applied so that carriers flow from the high density to low density region, one can imagine that the volume around a fixed number of carriers must increase as the carriers move towards the lower doped region.

At constant temperature and in thermal equilibrium there is no current as the diffusion current is balanced by the drift current associated with the built-in electric field caused by the graded doping density. As a current is applied to the semiconductor the built-in field is reduced so that the carriers diffuse from the high to low doping density. This causes a temperature reduction on the low doped side which continues until the entropy is constant throughout the semiconductor. Since the entropy per electron equals the distance between the conduction band edge and the Fermi energy plus 5/2 kT Om finds that the conduction band edge is almost parallel to the Fermi energy.

An ideal isentropic expansion is not obtained due to the Joule heating caused by the applied current and the thermal losses due to the thermal conductivity of the material. The need to remove heat at the low temperature further increases the lowest achievable temperature.

### Methods

In accordance with these inventions, methods of forming high temperature, wideband, infrared photodetectors include steps as follows: forming a wafer substrate of GaAs; forming elements configured as support electronics on the substrate; forming on the support electronics a multiple quantum well stack; and forming an ohmic contact layer of doped GaAs material on the stack. This is a most brief description. The following disclosure presents a detailed and enabling view of the methods of these inventions.

In the above mentioned method, the step described as ‘forming a stack’ is more precisely defined as including the following substeps: forming a well layer; forming a barrier layer; and repeating those steps in succession to form a repeating structure.

Formation of the well layer is described in better detail as follows: a first buffer portion is formed of pure undoped GaAs material; a doped portion is formed by introducing silicon atoms in a highly regulated fashion to control the density of GaAs; a second buffer portion is formed of undoped GaAs material.

Preferred versions include applying silicon dopant to effect a doping density greater than 1×10¹² atoms per square centimeter. In other versions silicon dopant is applied to effect a doping density of at least 1.5×10¹² atoms per square centimeter.

Additional steps to perfect a photodetector apparatus of these inventions may further include steps: cleaving an entrance aperture surface on the substrate; forming a total internal reflection surface; and forming a beam dump on the substrate surface opposite the surface upon which sets the multiple quantum well stack Finally, the entire structure may be brought into thermal contact with a semiconductor type of thermo electric cooler.

One will now fully appreciate how infrared photodetectors which operate at high temperatures are arranged, formed and used. Although the present invention has been described in considerable detail with clear and concise language and with reference to certain preferred versions thereof including the best mode anticipated by the inventor, other versions are possible. Therefore, the spirit and scope of the invention should not be limited by the description of the preferred versions contained therein, but rather by the claims appended hereto.

What is claimed is:

1) A quantum well type infrared photodetector apparatus, said apparatus comprising a plurality of wells and a plurality of barriers formed of alternating layers of gallium-arsenide material and aluminum-gallium-arsenide material respectively, said gallium-arsenide layers being highly doped with n-type dopant.

2) A photodetector apparatus of claim 1, said n-type dopant is silicon atoms.

3) A photodetector apparatus of claim 2, said dopant is applied in a density of greater than one trillion silicon atoms per square centimeter.

4) A photodetector apparatus of claim 3, said apparatus operated at a temperature greater than 100 Kelvin.

5) A photodetector apparatus of claim 4, said apparatus operated at room temperature.

6) A photodetector apparatus of claim 3, having a response bandwidth greater that 4 GHz.

7) A photodetector apparatus of claim 3, said dopant is applied in gallium arsenide layers, the dopant is silicon atoms at a density of about 1×10¹² atoms per square centimeter.

8) A photodetector apparatus of claim 3, said dopant is applied in gallium arsenide layers, the dopant is silicon atoms at a density between 1×10¹² and 3×10¹² atoms per square centimeter.

9) A photodetector apparatus of claim 3, said plurality of wells and barriers forming a stack structure on a IR transparent substrate having an entrance aperture forming an acute angle with respect to said stack whereby an optical beam passing into said aperture may be incident upon and thereby coupled to said stack of wells and barriers.

10) A photodetector apparatus of claim 9, said substrate further having a total internal reflection type mirror disposed on said stack structure and further an opaque beam dump on said substrate surface opposite stack structure.

11) Methods of forming a quantum well type infrared photodetector apparatus, said apparatus comprising a plurality of wells and a plurality of barriers formed of alternating layers of gallium-arsenide material and aluminum-gallium-arsenide material, said gallium-arsenide layers being doped with n-type dopant, said methods comprising the steps:
a) forming a rigid wafer substrate of GaAs crystalline material in an epitaxy process;
b) forming upon a flat surface said substrate a foundation of elements configured as support electronics;
c) forming upon said support electronics a multiple quantum well stack of well layers and barrier layers; and
d) forming upon said stack an ohmic contact layer of doped GaAs material.

12) Methods of claim 11, said forming a multiple quantum well stack step further comprising the substeps:
i) forming a well layer of n-type doped GaAs;
ii) forming a barrier layer of homogenous AlGaAs upon said well layer; and
iii) repeating both steps c) and d) in succession a plurality of times to form a repeating structure.

13) Methods of claim 12, where step iii) is repeated at least seventy times to form a multiple quantum well stack having at least seventy wells.

14) Methods of forming a photodetector apparatus of 12, where step i) is further defined as comprising substeps:
A) forming a first buffer portion of said well layer from pure undoped GaAs material;
B) forming a doped portion of said well layer by introducing silicon atoms in a regulated fashion to GaAs material as the doped portion of said well layer is formed; and
C) forming a second buffer portion of said well layer from pure undoped GaAs material.

15) Methods of forming a photodetector apparatus of 14, where step B) is applying silicon atoms dopant to effect a doping density greater thin 1×10¹² atoms per square centimeter.

16) Methods of forming a photodetector apparatus of 14, where step B) is applying silicon atoms dopant to effect a doping density of at least 1.5×10¹² atoms per square centimeter.

17) Methods of forming a photodetector apparatus of 14, further comprising the steps:
f) cleaving an entrance aperture surface having an acute angle with respect to a substrate surface of said substrate of GaAs material;
g) forming a total internal reflection surface; and
h) forming a beam dump on substrate surface opposite the surface of the multiple quantum well stack

20) A quantum well type infrared photodetector apparatus, said photodetector apparatus comprising in combination:
a) a quantum well infrared photodetector; and
b) a thermo electric cooler,
said quantum well photodetector being thermally coupled to said thermo electric cooler.

21) The photodetector apparatus of claim 20, said quantum well type infrared photodetector further comprising a region of high doping.

22) The photodetector apparatus of claim 21, said ‘high doping’ is greater than 1×10¹² atoms per square centimeter.

23) The photodetector apparatus of claim 21, said ‘high doping’ is formed in a region which is one atom layer after undoped gallium arsenide is applied to a barrier layer.

24) The photodetector apparatus of claim 21, thermal coupling is a pad of high thermal conductivity.

25) The photodetector apparatus of claim 21, said thermal electric cooler is a multi-stage cooler.
